(19) United States
(12) Patent Application Publication
(10) Pub. No.: US 2004/0169638 A1
(43) Pub. Date: Sep. 2, 2004

(54) Method and apparatus for user interface

(76) Inventor: Adam S. Kaplan, (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/729,796

(22) Filed: Dec. 9, 2003

Related U.S. Application Data
(60) Provisional application No. 60/431,710, filed on Dec. 9, 2002.

(51) Int. Cl. G09G 5/00

(52) U.S. Cl. 345/156

(57) ABSTRACT

A method and apparatus for computer 100 input control by multiple transceivers 110 and 115 worn on a user's fingers. In particular, computer input control signals, such as those for controlling a cursor on a display 130, are generated based on changes in the position of at least two transceivers 110 and 115 worn on a user's fingers.

### RELATED APPLICATIONS

This application claims priority to U.S. Provisional Application No. 60/431,710, filed on Dec. 9, 2002, which is incorporated by reference in its entirety.

### FIELD OF THE INVENTION

The present invention relates to a method and apparatus for user-interface and, more particularly, allowing a user to control a device by moving mobile transceivers.

### BACKGROUND OF THE INVENTION

The way a person interfaces with a processor has evolved in the past few decades. Initially, a programmer interfaced with a computer using punch cards encoded with information in binary. The first substantial advance in interfaces came with the keyboard. No longer did a programmer need to translate instructions into binary and create punch cards to operate a computer. The next major advance in interfaces came with a mouse, which ultimately led to graphical user interfaces.

A mouse provides a method of interfacing with a computer by translating the movement of a user's hand around a mousepad into control signals. As the mouse is moved, control signals indicating the direction and speed of motion are generated so that the cursor on the display responds accordingly. When buttons are pressed, or a mouse-wheel is rotated, control signals are also generated so that the cursor responds appropriately.

However, a mouse has limitations. First, the workstation must provide a conveniently located area for the mouse next to the keyboard. Second, a mouse usually has a cable connecting it to the computer. This cable sometimes restricts the user's movement of the mouse. Third, a user often rests the heel of her hand on the mouse pad exacerbating carpal tunnel syndrome. Fourth, most mice use a mouse ball to translate the movement of the user's hand into control signals. When the mouse ball gets dirty, the user's hand movements are not smoothly translated into cursor movement.

Many advances have been made in the design of mice in order to alleviate the problems associated with mice.

Optical mice have been developed to eliminate the problem caused when a mouse ball gets dirty impeding the smooth movement of the cursor. These optical mice, rather than using a mouse ball, have a light underneath that is used to measure the movement of the mouse. An optical mouse eliminates the problem of the mouse ball getting dirty, but it does not address any of the other problems with mice.

In addition, wireless mice have been developed to alleviate the problem resulting from the wire connecting the mouse to the computer impeding the movement of the mouse. Also, wireless optical mice have been developed to address both problems at once. However, if the user has carpal tunnel syndrome, a wireless optical mouse will still exacerbate this problem.

Another improvement of a mouse that has been developed to reduce the impact on carpal tunnel syndrome is a hand-held mouse. A hand-held mouse is a trackball that the user can hold in his hand. Unfortunately, trackballs are not as convenient to operate as regular mice.

Another problem with a mouse arises when it is used in conjunction with a laptop. Because it is often inconvenient to carry a mouse with a laptop, touchpads are often used. Touchpads, unfortunately, do not provide the same precision or comfort as regular mice.

While personal data assistants (“PDAs”) would benefit from the use of a mouse to interface with the PDA, it is not feasible to carry a mouse with a PDA. The purpose of a PDA is that it is easy to carry around. A mouse would greatly reduce the ease with which a person could carry the PDA around.

There has also been a cursor control device designed that uses a single ring to control the cursor. This cursor control device is described in detail in U.S. Pat. No. 5,638,092. Two transceivers are used to measure the motion along the x-axis and the y-axis. There are many drawbacks to the cursor control device disclosed in the '092 patent. First, this cursor control device only measures motion and direction. As a result, to avoid the cursor jittering on the screen while the user is typing, a switch must be held down whenever the user wants to control the cursor with the ring. This design limits the position on the user's finger that the ring can be placed. Also, since a switch must be held down whenever the user wants to control the cursor, only a single ring can be used. Accordingly, it is not possible for this design to simulate multiple buttons. Another drawback of this design is that because it can only determine the direction and speed of the ring, it cannot simulate a touch screen when the user's hand is near the screen.

### BRIEF SUMMARY OF THE INVENTION

The present invention mitigates the problems associated with the prior art and provides a unique method and apparatus for a user to interface with technology.

One embodiment of the present invention is a system for controlling the operation of an electronic device by a user. The system comprises at least two transmitters in communication with the electronic device. Each of the transmitters are adapted to be worn on the user's fingers. At least one receiver is configured to receive signals from the transmitters. A control module is in communication with the receiver and is configured to send control signals to said electronic device.

Another embodiment is a method of generating control signals for controlling an electronic device. The method comprises calculating a three dimensional location of each of at least two transmitters. A control signal is generated based, at least in part, on changes to the location of at least one of the transmitters.

Yet another embodiment is a system for controlling an electronic device. The system comprises at least two transmitters adapted to be worn on a user's fingers. At least three receivers are configured to receive a signal from the transmitters. A controller is configured to generate a control signal based, at least in part, on changes to a location of at least one of the transmitters. The controller is configured to calculate the location of each of the transmitters based on a distance of each of the transmitters measured from each of the receivers.

Another embodiment is a system for controlling an electronic device. The system comprises means for calculating a three dimensional location of at least two transmitters. A means for generating a control signal may generate the control signal based, at least in part, on changes in the location of at least one of the transmitters.

### BRIEF DESCRIPTION OF THE DRAWINGS

The above and other features and advantages of the invention will be more readily understood from the following detailed description of the invention which is provided in connection with the accompanying drawings.

FIG. 1 is an illustration of an exemplary embodiment of the present invention implemented on a personal computer;

FIG. 1a is an illustration of a second embodiment of the present invention implemented on a laptop;

FIG. 1b is an illustration of a third embodiment of the present invention implemented on a PDA;

FIG. 2 is a block diagram of an exemplary embodiment of the present invention implemented with a microprocessor;

FIG. 2a is a block diagram of an exemplary embodiment of the present invention implemented with software;

FIG. 3 is a flowchart of the initialization procedure of the present invention implemented on a computer system;

FIG. 3a is a flowchart of the initialization procedure of the present invention implemented on a laptop;

FIG. 3b is a flowchart of the initialization procedure of the present invention implemented on a PDA;

FIG. 4 is a flowchart of the calibration procedure of an exemplary embodiment of the present invention;

FIG. 5 is a flowchart of the operation of an exemplary embodiment of the present invention;

FIG. 5a is a continuation of a flowchart of the operation of an exemplary embodiment of the present invention;

FIG. 6 is a flowchart of the operation of the mobile transceivers in an exemplary embodiment of the present invention;

FIG. 7 is a flowchart of the initialization procedure for a fourth embodiment of the present invention;

FIG. 7a is a flowchart of the operation of a fourth embodiment of the present invention; and

FIG. 7b is a block diagram of a mobile transceiver for use with a fourth embodiment of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to make and use the invention, and it is to be understood that structural changes may be made and equivalent structures substituted for those shown without departing from the spirit and scope of the present invention.

Embodiments of the invention comprise a method and apparatus for interfacing with a device (e.g. a computer, personal data assistant (“PDA”), ATM Machine, etc.) using transceivers and a microprocessor or an application specific integrated circuit (“ASIC”) connected to the device and transceivers worn by a user on the user's mobiles.

In an exemplary embodiment of the present invention, stationary transceivers placed around a device determine the location, relative to the device, in three-dimensional space, of the user's fingers from the length of time a signal takes to travel from the stationary transceivers to a set of mobile transceivers worn by the user. As the user moves the mobile transceivers around near the stationary transceivers, the ASIC generates control signals, including control signals similar to those of a mouse, so the user can control the device based on changes in the location of the user's mobile transceivers.

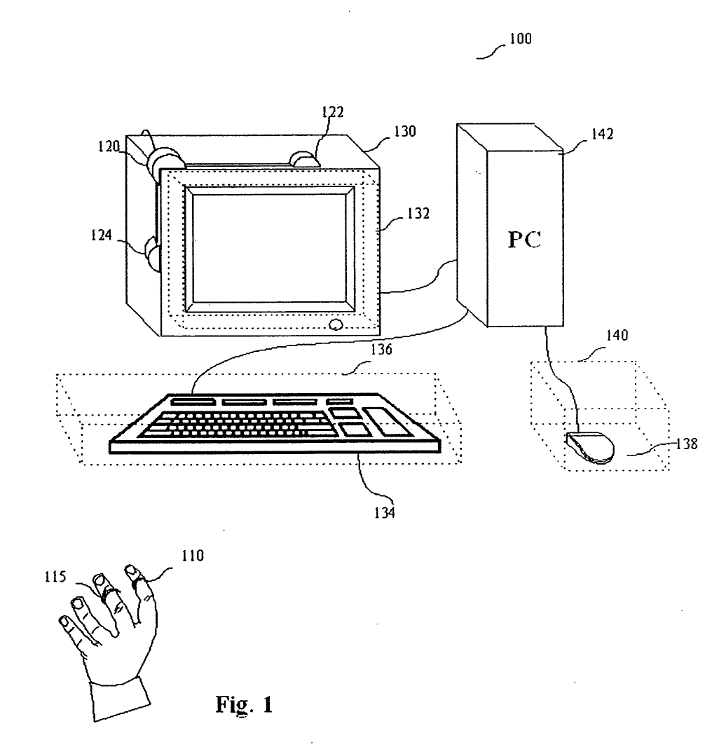

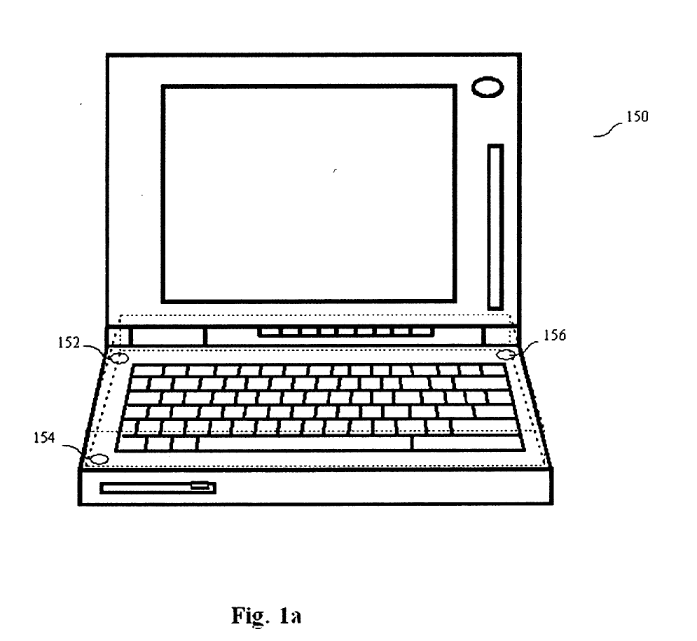

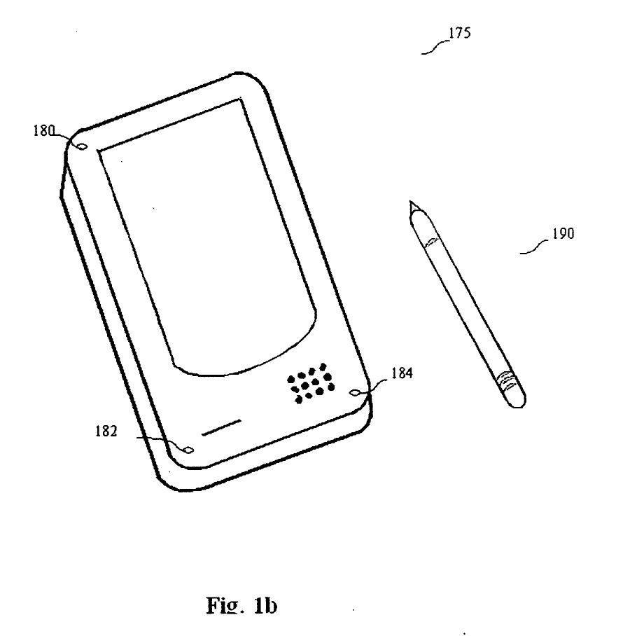

For example, when the user moves both mobile transceivers in unison, the position of the cursor on the display will respond accordingly; if the user moves a mobile transceiver quickly forward a short distance and quickly back, a control signal—similar to the control signal generated by a mouse when a button is pressed—is generated. The devices that can be controlled using the present invention include, but are not limited to, a computer, as depicted in FIG. 1, a laptop, as depicted in FIG. 1a, a personal digital assistant (PDA), as depicted in FIG. 1b, computer peripherals, a telephone, a cellular telephone, a digital camera, a television, a stereo, a light switch, a lamp, vehicular controls, a thermostat, kitchen and other home appliances (vacuum cleaner, oven, stove, toaster, microwave oven, blender, garbage disposal, dishwasher, icemaker, etc.) an automatic teller machine, a cash register, or any other device that could use buttons, switches, knobs or levers to allow a user to control it. Information on the Bluetooth™ protocol can be found on the Internet at Bluetooth.org.

As shown in FIG. 1, transceivers 110, 115, 120, 122 and 124 are transceivers such as are well known in the art. They may, but do not necessarily have to, operate in accordance with Bluetooth™ protocol. The Bluetooth™ wireless specification allows transceivers to establish a pico-net with each other as they move in and out of range of each other. The transceivers may also, but do not necessarily have to, be a radio frequency identification (“RFID”) system. Information on RFID systems can be found in the Internet at RFID.org.

When implemented on computer system 100, the device driver for the present invention is initialized when installed and when a new user is added. The initialization procedure (described below) allows the user to enter information about the locations of display 200, keyboard 134 and mouse 138 relative to transceiver 120, transceiver 122 and transceiver 124. Embodiments of the present invention can work with mouse 138 connected to computer system 100 or without mouse 138. The initialization procedure for laptop 150 or PDA 175 requires fewer steps since the location of laptop 150 or PDA 175 relative to transceiver 120, transceiver 122 and transceiver 124 is already fixed and known.

By determining the location of display 130, the system described below can simulate the operation of a touch screen when mobile transceiver 110 and mobile transceiver 115 are within user-defined distance 132 of display 130. In addition, by determining the location of keyboard 134 and mouse 138, the system described below can generate no control signals to move the cursor when mobile transceiver 110 and mobile transceiver 115 are within user-defined area 136 (around keyboard 134) or user-defined area 140 (around mouse 138), allowing the user to operate keyboard 134 or mouse 138 without the cursor moving around display 130.

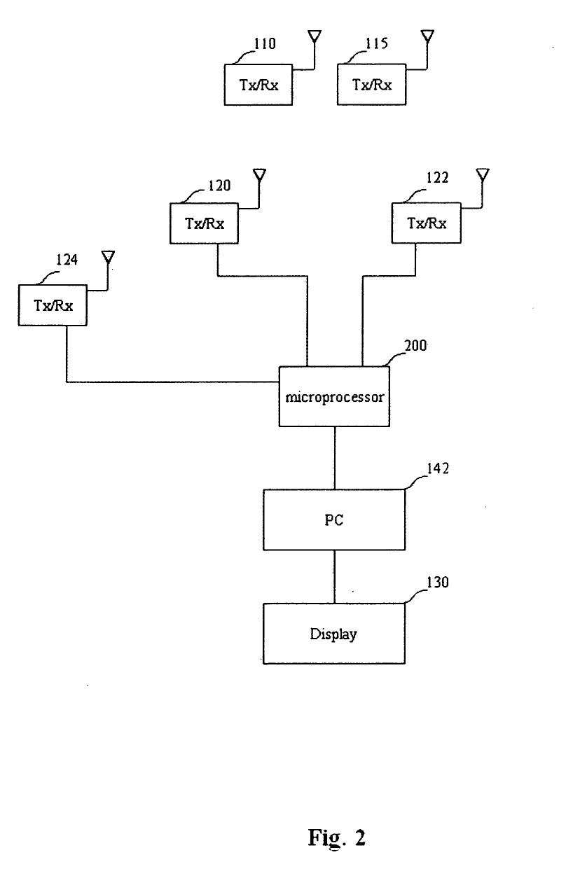

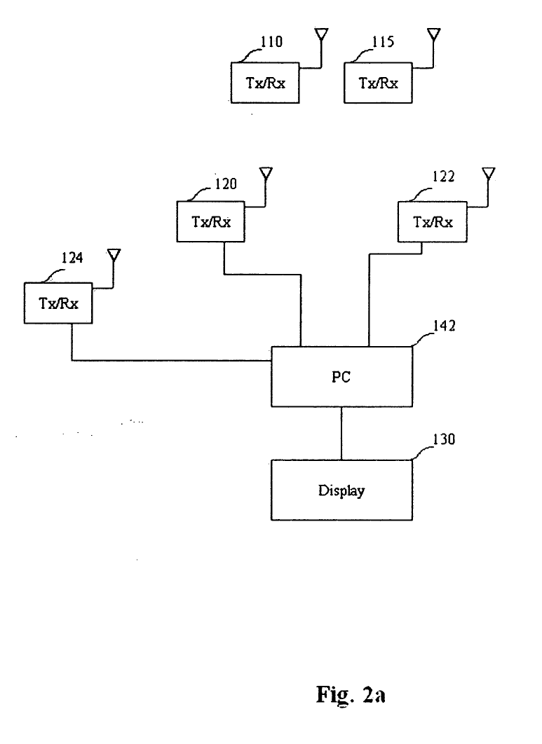

FIG. 2 is a block diagram of an exemplary embodiment of the present invention implemented on computer system 100. Transceiver 120, transceiver 122 and transceiver 124 are each connected to microprocessor 200 and placed on display 130 (as depicted in FIG. 1). Transceiver 120, transceiver 122 and transceiver 124 are connected with a rigid support so that the distance between transceiver 120, transceiver 122 and transceiver 124 can be measured during manufacturing and the distance used during the calibration procedure described below. Microprocessor 200 is connected to computer 142 either through a universal serial bus (“USB”) port or through a control card.

Microprocessor 200 is not a necessary component of the present invention. The same functionality can be achieved with software installed in computer 142 by connecting transceiver 120, transceiver 122 and transceiver 124 directly to computer 142 through a USB port or through a control card as depicted in FIG. 2a. However, to prevent computer 142 from being slowed down by calculations, it is presently preferable to use microprocessor 200 (a microprocessor or an application specific integrated circuit (“ASIC”)) to perform the necessary calculations. Similarly, laptop 150 or PDA 175 can have either a separate microprocessor to operate the present invention or perform the necessary calculations using installed software.

Microprocessor 200, transceiver 120, transceiver 122, and transceiver 124 may each comprise means for calculating a three dimensional location of at least two transmitters. Microprocessor 200 may comprise means for generating a control signal. In another embodiment, computer 142, laptop 150, or PDA 172 may comprise means for calculating a three dimensional location of at least two transmitters. Computer 142, laptop 150, or PDA 172 may also comprise means for generating a control signal.

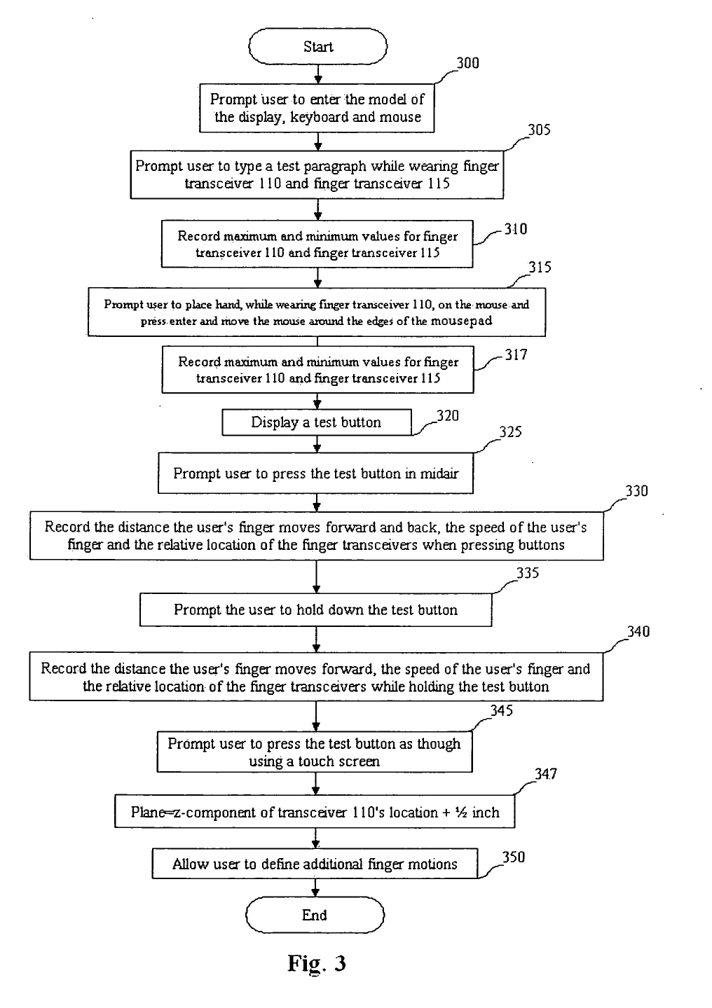

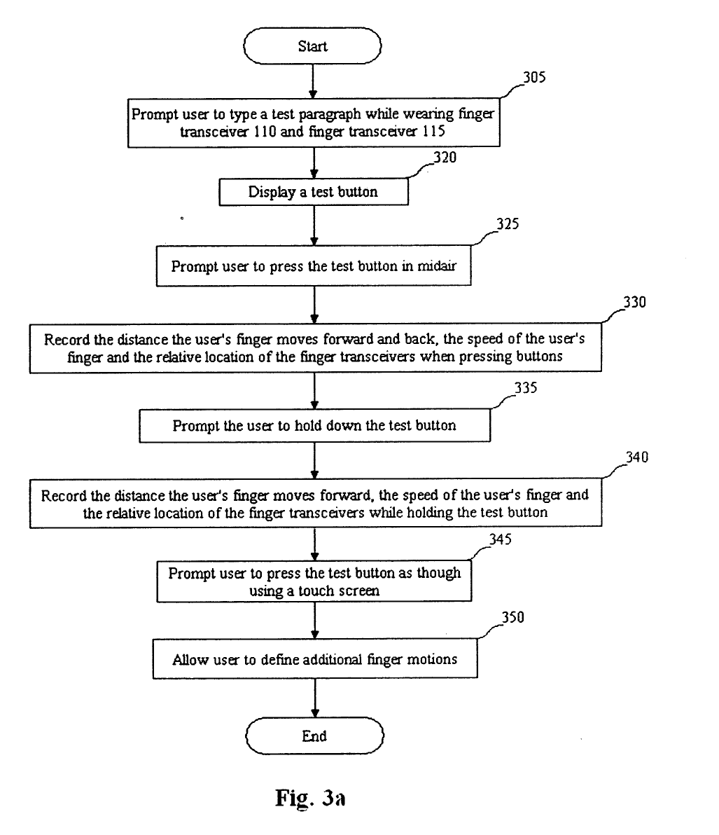

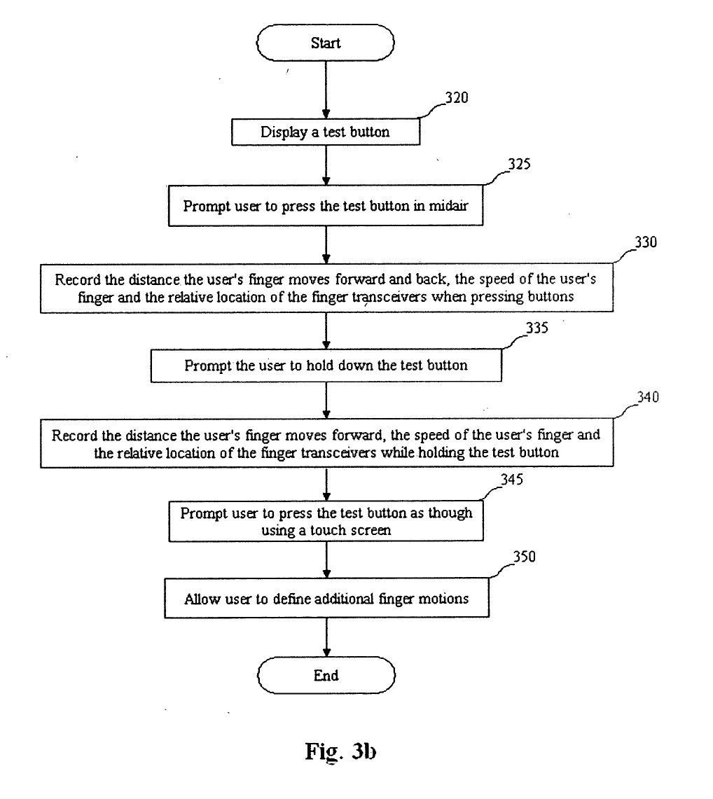

FIG. 3 is a flowchart of the operation of the initialization procedure of the present invention implemented on computer system 100. The user is prompted to enter the model of display 130, keyboard 134 and mouse 136 (step 300). The device driver contains, or can look-up on over the Internet, information on the dimensions of each display, keyboard and mouse. Once the device driver retrieves the dimensions of display 130, keyboard 134 and mouse 138, the relative locations are determined. The location of the keyboard is determined by prompting the user to type a test paragraph, while wearing mobile transceiver 110 and mobile transceiver 115 (step 305). Microprocessor 200 records the maximum and minimum x, y and z values for mobile transceiver 110 and 115 while the user is typing the test paragraph (step 310). From this information, microprocessor 200 defines the area of inoperation around the keyboard as 5 planes. The top plane (“ceiling”) is defined as the maximum y-component of mobile transceiver 110 and mobile transceiver 115 while the user is typing the test paragraph. The user is given the option to raise the height used for the ceiling to create an additional buffer zone of inoperation. The user is also given the option to only use only the ceiling to define area of inoperation 136. If the user selects this option, then, the area of inoperation 136 is defined as a plane instead of a box.

If the user does not select this option, then the front plane (“front”), back plane (“back”), left plane and right plane are defined. The front plane is defined as the minimum z-component of mobile transceiver 110's location in step 310; the back plane is defined as the maximum z-component of mobile transceiver 110's location in step 310; the left plane is defined as the minimum x-component of mobile transceiver 110's location in step 310; and the right plane is defined as the maximum x-component of mobile transceiver 110's location.

The location of mouse 138 is determined by prompting the user to place the hand wearing mobile transceiver 110 and mobile transceiver 115 on the mouse, press enter and move it around its area of operation (step 315). Microprocessor 200 records the maximum and minimum x, y and z values for mobile transceiver 110 and 115 while the user is typing the test paragraph (step 317). The bounds of the user's movements can be used to define a box of inoperation 140 around mouse 138 in the same manner that the box of inoperation around keyboard 134 was created.

The device driver then displays a test button (step 320) and prompts the user to execute a button-pushing mobile motion (as though pressing a real button) while the user's mobile transceivers are in midair and the cursor is over the test button (step 325). The device driver records information about the user's button-pushing mobile transceiver motions. For example, the distance the user's mobile transceiver moves forward and back, the speed of the user's mobile transceiver and the relative location of the mobile transceivers 110 and 115 when pressing buttons (step 330). The user is then prompted to execute a button-holding mobile transceiver motion as though holding down the test button (step 335). The device driver records information about the user's button-holding mobile transceiver motions, for example, the distance the user's mobile transceiver moves forward, the speed of the user's mobile transceiver and the relative location of the mobile transceivers 110 and 115 when holding a button (step 340).

Once the user's button-pushing and button-holding mobile transceiver motions are recorded, the device driver prompts the user to press the test button as though using a touch screen (step 345) to define the area around the monitor 132 in which the present invention will behave like a touch screen. This step is necessary because mobile transceiver 110 and mobile transceiver 115 will be farther away from display 130 for a user with long mobiles than they will be for a user with short mobiles. The location of display 130 is a plane defined as z=0. The plane parallel to display 130 is defined as the z₁₁₀ plus ½ inch (step 347). When mobile transceiver 110 is between this plane and display 130, the system will simulate a touch screen.

In addition, the user will be given the opportunity to define other hand motions (step 350). For example, the user can specify that when mobile transceiver 110 and mobile transceiver 115 reverse positions on the x-axis (the user turned his hand upside down), microprocessor 200 will generate control signals for scrolling a window up, down, left or right depending on the user's hand motions.

Once the initialization procedure is completed, it can be run anytime to modify the settings or add a new user with different settings. The user can change the active user by clicking on an icon in the system tray or, for a computer system with voice recognition software installed on it, by making a verbal request to do so.

Fewer steps are necessary for initialization on laptop 150. Transceivers 120, 122 and 124 each have a fixed position relative the laptop's display when implemented on laptop 150. In addition, since transceivers 120, 122 and 124 will be installed on a laptop during manufacturing, information regarding the dimensions of the laptop's display can be entered by the manufacturer. However, an additional sensor to measure the angle of the laptop's display relative to the laptop's keyboard is necessary. Accordingly, as depicted in FIG. 3a, the initialization procedure described above is adapted to laptop 150 by removing steps 300 and 315.

The initialization procedure for PDA 175 is the same as the initialization for laptop 150 if PDA 175 has a keyboard. However, fewer steps are necessary for initialization on PDA 175 if PDA 175 has no keyboard. As depicted in FIG. 3b, step 305 is removed from FIG. 3a. Since there is no keyboard, microprocessor 200 does not need information regarding the position of mobile transceivers 110 and 115 while typing. In addition, instead of using two mobile transceivers, one is sufficient to simulate the operations of a stylus pen on a touchpad. Also, instead of mobile transceivers, a transceiver can be installed in a stylus pen for use with PDA 175. In such a case, the invention will operate in the same manner described below regarding mobile transceivers 110 and 115.

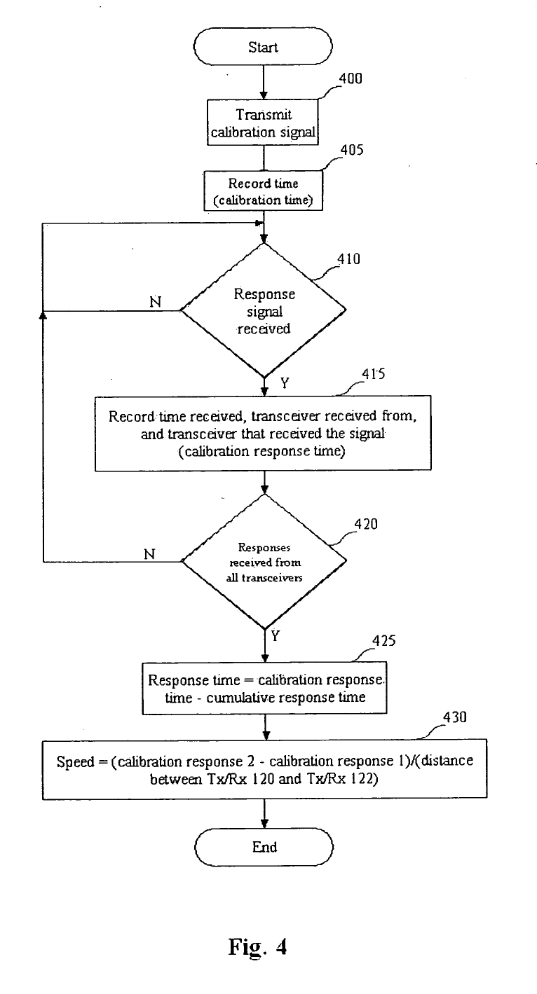

The calibration procedure (used to determine the length of time a signal takes to travel a known distance) is described in FIG. 4. The calibration procedure is used to calculate the response time of transceivers 120, 122 and 124 and the speed of the signal. The response time is calculated so that it can later be subtracted from the response time of mobile transceiver 110 or 115. By calculating the speed of the signal, any differences due to temperature, humidity or atmospheric pressure will be accounted for periodically during the operation of the present invention.

When the present invention is activated, by turning on both the computer and the rings, or by moving the rings outside of user-defined areas of inoperation 136 and 140, microprocessor 120 causes transceiver 122 to transmit a calibration signal (step 400) and microprocessor 200 records the time (hereinafter “calibration time”) or a timer is started (step 405).

Microprocessor 200 then checks if a response signal was received from transceiver 120, transceiver 122 or transceiver 124 (step 410). If no signal has been received, microprocessor 200 repeats step 510. When microprocessor 200 receives a response signal from transceiver 120, transceiver 122 or transceiver 124, microprocessor records the time (hereinafter “cumulative response time”) and the transceiver that received the signal. The cumulative response time is the length of time it takes for transceiver 122 to receive the signal to transmit a signal from microprocessor 200 (in the case of the calibration procedure, the signal is the calibration signal; in the case of the normal operation of the present invention, the signal is the initiation signal described below), the length of time it takes transceiver 122 to transmit the signal, the length of time transceiver 122 takes to receive the signal, the length of time mobile transceiver 110 or 115 takes to transmit a response signal, the length of time it takes transceiver 120, 122 or 124 to receive the response signal and the length of time it takes for transceiver 120, 122 or 124 to notify microprocessor 200 that the response was received. If microprocessor 200 has not received a response signal at transceiver 120, transceiver 122 and transceiver 124 (step 420), microprocessor 120 repeats step 410. As a response signal is received from mobile transceiver 110 and 115 at each of transceivers 120, 122 and 124, the time is recorded (hereinafter “calibration response time”)

If a response signal has been received from transceiver 120, transceiver 122 and transceiver 124 in step 420, microprocessor 200 calculates the response time (step 425) and the speed (step 430). The response time and speed are calculated as described in Formula 1 and Formula 2, respectively.

Response time=calibration response time−cumulative response time Formula 1

Speed=response time₁₂₂/the distance between transceivers 122 and 124 Formula 2

The distance between transceiver 122 and transceiver 124 is measured during manufacturing and input into microprocessor 200. The distance between transceiver 122 and transceiver 124 is fixed. The response time and speed are calculated periodically during the normal operation of the present invention to account for any differences that come about during operation. For example, the heat generated by the normal operation of the present invention may affect the speed with which components of the present invention react.

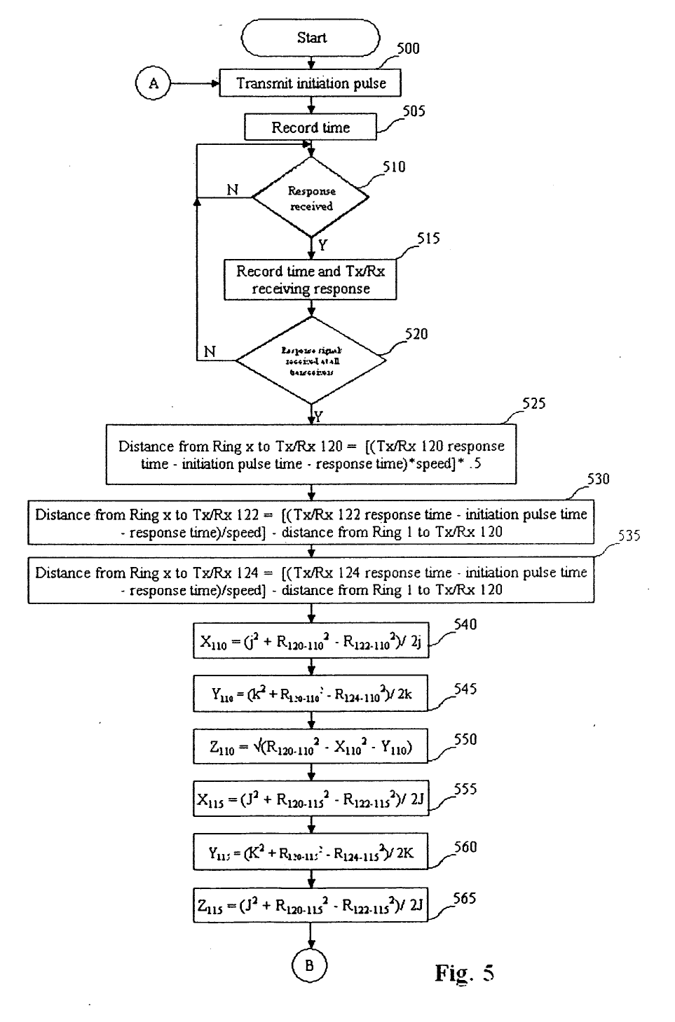

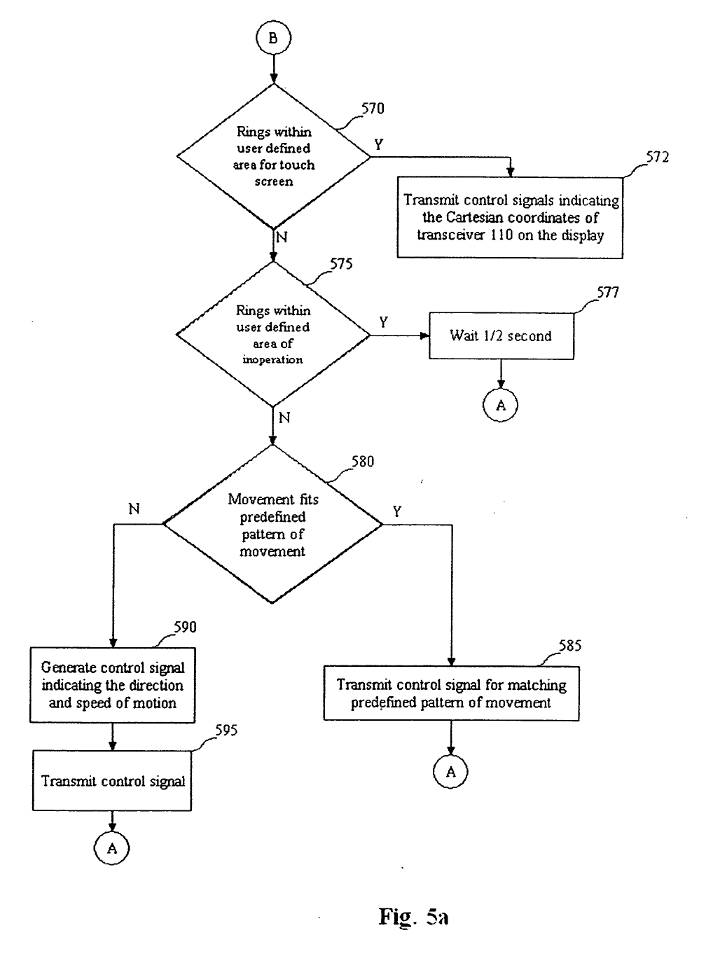

Once the response time and the speed are calculated (steps 425 and 430), the location of the rings can be determined. FIG. 5 and FIG. 5a are a flowchart of the normal operation of an exemplary embodiment of the present invention. Microprocessor 200 transmits an initiation signal from transceiver 122 (step 500) and records the time (or starts a timer) (step 505). The initiation signal is received by mobile transceiver 110 and mobile transceiver 115.

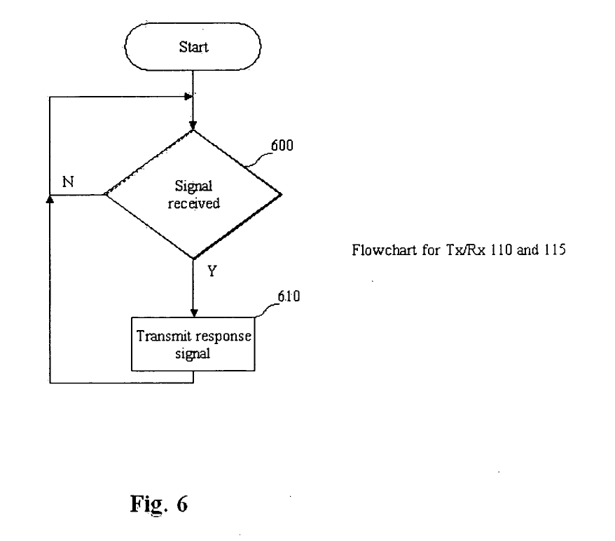

When mobile transceiver 110 and mobile transceiver 115 each receive the initiation signal (step 600), as depicted in FIG. 6, each transmits a response signal on a different frequency (step 610).

If no response signal is received by microprocessor 200 at step 510, microprocessor 200 returns to step 510 to continue checking until a response signal has been received from each mobile transceiver 110 and 115 at each transceiver 120, 122 and 124. When a response signal is received at step 510, microprocessor 200 records the time the response signal was received, the transceiver 120, 122 or 124 that received the signal and the mobile transceiver 110 or 115 that transmitted the signal (step 515) (e.g. Response time₁₁₀₋₁₂₀). This process continues until microprocessor 200 has received response signals for each mobile transceiver 110 and 115 at each transceiver 120, 122 and 124 (step 520).

Once microprocessor 200 receives response signals from each mobile transceiver 110 and 115 at each transceiver 120, 122 and 124, the distance from mobile transceiver 110 and 115 to each transceiver 120, 122 and 124 can be calculated (steps 520, 525 and 530). The distance between mobile transceiver X 110 or 115 and transceiver 122 is calculated as described in Formula 3:

Distanceₓ₋₁₂₀=(Response timeₓ₋₁₂₀−cumulative response time)*speed*½ Formula 3

The cumulative response time is subtracted from Response timeₓ₋₁₂₀ to determine the amount of time between transmitting the initiation signal and receiving the response signal so that the time remaining figure solely represents the amount of time for the initiation signal to travel from transceiver 120 to mobile transceiver 110 or 115 and back. When this figure is multiplied by the speed (calculated in the calibration procedure described above), the result is the distance from transceiver 120, 122 or 124 to mobile transceiver 110 or 115 and back. Once microprocessor 200 divides this result by 2, the resulting figure is the distance from transceiver 120, 122 or 124 and mobile transceiver 110 or 115.

Once the distance from mobile transceiver 110 and 115 to transceiver 122 is calculated, microprocessor 200 can calculate the distance from each mobile transceiver 11.0 and 115 to each of the other transceiver 122 and 124 as described in Formula 4 and Formula 5.

Distanceₓ₋₁₂₂=(Response timeₓ₋₁₂₂−cumulative response time)*speed−distanceₓ₋₁₂₀ Formula 4

Distanceₓ₋₁₂₄=(Response timeₓ₋₁₂₄−cumulative response time)*speed−distanceₓ₋₁₂₀ Formula 5

The only difference between the calculation of the distance between each mobile transceiver 110 and 115 and transceiver 120 and the calculation of the distance between each mobile transceiver 110 and 115 and transceiver 122 and 124 is the last step of the calculation. For transceiver 120, the result is halved because the initiation signal is sent from transceiver 120. For transceiver 122 and 124, the distance from mobile transceiver 110 or 115 to transceiver 120 is subtracted because the initiation signal still came from transceiver 120, so that must be subtracted in order to determine the distance from mobile transceiver 110 or 115 and transceiver 122 and 124 (steps 530 and 535).

After microprocessor 200 calculates the distances for each mobile transceiver 110 and 115 to each transceiver 120, 122 and 124, the location in three-dimensional space of each mobile transceiver 110 and 115 can be calculated. The location is computed using Cartesian coordinates. Formulas 6, 7 and 8, discussed below, were derived from the formula for the location of a point on a sphere (Formula 6).

Radius=sq.rt.[(x−j)²+(y−k)²+(z−m)²] Formula 6

The distances calculated for the distance from each mobile transceiver 110 and 115 to each transceiver 120, 122 and 124 constitute the radii of spheres centered on the corresponding transceiver 120, 122 and 124. The x, y and z values for the location of mobile transceiver 110 are equal when using Distance_{110/120}, Disantce₁₁₀₋₁₂₂ or Distance₁₁₀₋₁₂₄. For transceiver 120, which is located at the origin of the Cartesian coordinates, j=0, k=0, m=0. In order to simplify the calculations, the x-axis of the Cartesian coordinates is defined such that transceiver 120 is at the origin, transceiver 122 lies on the x-axis and transceiver 124 lies on the y-axis. As a result, for transceiver 122, k=0, m=0 and j=the distance along the x-axis between transceiver 122 and transceiver 120. Similarly, for transceiver 124, j=0, m=0 and k=the distance along the y-axis between transceiver 124 and transceiver 120. Applying basic algebra to Formula 6, Formulas 7, 8 and 9 are derived for the x-component, y-component and z-component of mobile transceiver 110's location, respectively.

X₁₁₀=(j²+R₁₂₀₋₁₁₀²−R₁₂₂₋₁₁₀²)/2j Formula 7

Y₁₁₀=(k²+R₁₂₀₋₁₁₀²−R₁₂₄₋₁₁₀²)/2k Formula 8

Z₁₁₀=√(R₁₂₀₋₁₁₀²−X₁₁₀²−Y₁₁₀²) Formula 9

After microprocessor 200 calculates the x, y and z components of mobile transceiver 110 (steps 540, 545 and 550), the same process is repeated for the x, y and z components of mobile transceiver 115's location (steps 555, 560 and 565). Microprocessor 200 then determines whether mobile transceiver 110 is between the plane (defined in step 347) and display 130 (step 570). If z₁₁₀ is positive and less than the value of the plane, microprocessor 200 will generate control signals indicating the position on the screen that the cursor should move to (step 572). If mobile transceiver 110 is above, below, to the right or left of display 130, the cursor will appear at the edge of display 130 nearest the location of mobile transceiver 110.

If mobile transceiver 110 is not within the user-defined area for the touch screen in step 570, microprocessor 200 determines whether mobile transceiver 110 is within a user-defined area of inoperation (step 575). If y₁₁₀ is less than the value for the ceiling, and the user selected to only use the ceiling in step 315, then microprocessor 200 does not generate any control signals and waits a ½ second before transmitting another initiation signal (step 577). If the user did not select to only use the ceiling in step 315, then microprocessor 200 checks if the x-component of transceiver 110's location is greater than the value for the left plane and less than the value for the right plane. If the x-component of mobile transceiver 110's location is between the values for the left and right planes, microprocessor 200 checks if the z-component of mobile transceiver 110's location is greater than the value for the front plane and less than the value for the back plane. If mobile transceiver 10's location is within the user-defined area of inoperation, microprocessor 200 does not generate any control signals and waits a ½ second before transmitting another initiation signal (step 577).

If mobile transceiver 110's location is not within user-defined area of inoperation 136, microprocessor 200 determines whether mobile transceiver 110 is within user-defined area of inoperation 140. If mobile transceiver 110's location is within user-defined area of inoperation 140, then microprocessor 200 does not transmit any control signals and waits a ½ second (step 577) before returning to step 500 to transmit another initiation signal.

If mobile transceiver 10's location is not within user-defined area of inoperation 136 and 140, microprocessor 200 checks if the movement of mobile transceiver 110 corresponds to a user-defined pattern of movement (step 580). If mobile transceiver 110's movement matches a user-defined pattern of movement (e.g. a button-pushing motion), microprocessor 200 transmits a control signal for the matching pattern of movement (step 585) and returns to step 500 to transmit another initiation signal. If mobile transceiver 110's movement does not match a user-defined pattern of movement in step 580, microprocessor generates a control signal indicating the corresponding direction and speed that the cursor should move on display 130 (step 590), transmits that control signal (step 595) and returns to step 500 to transmit another initiation signal.

Another feature of the present invention is that the user can “draw” in mid-air. The movement of mobile transceivers 110 and 115 is graphically represented on the display. If, for example, the user moves mobile transceivers 110 and 115 in a manner like writing, optical character recognition software can translate the graphical representation into text.

In addition, a graphical password function can be implemented. The user can set up a pattern of movement that must be enacted to gain access to a computer, files on that computer or to change the active user.

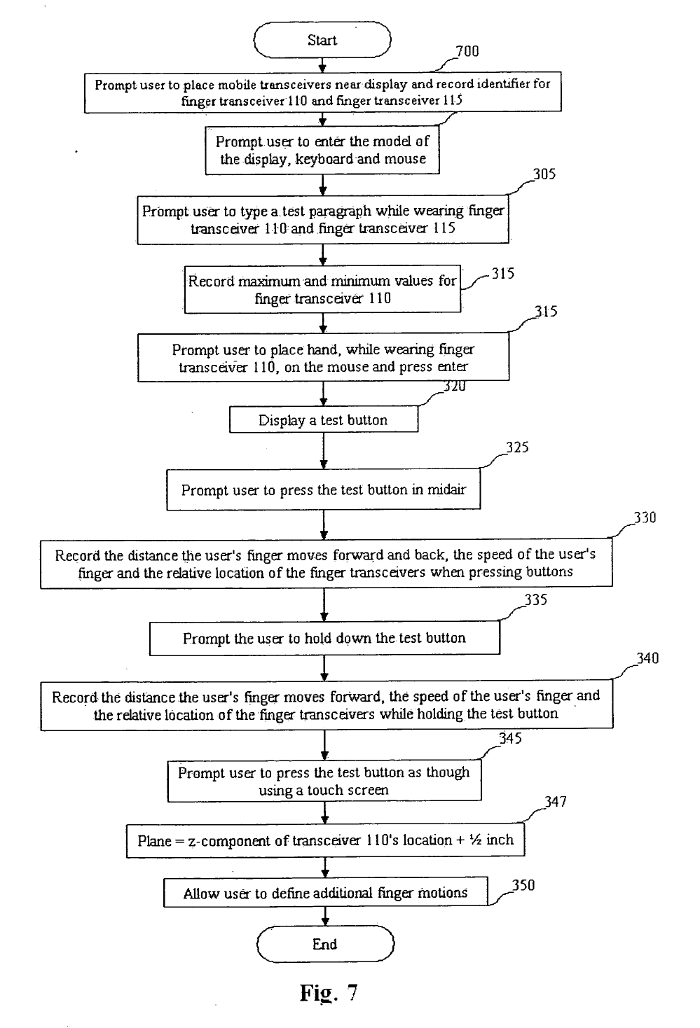

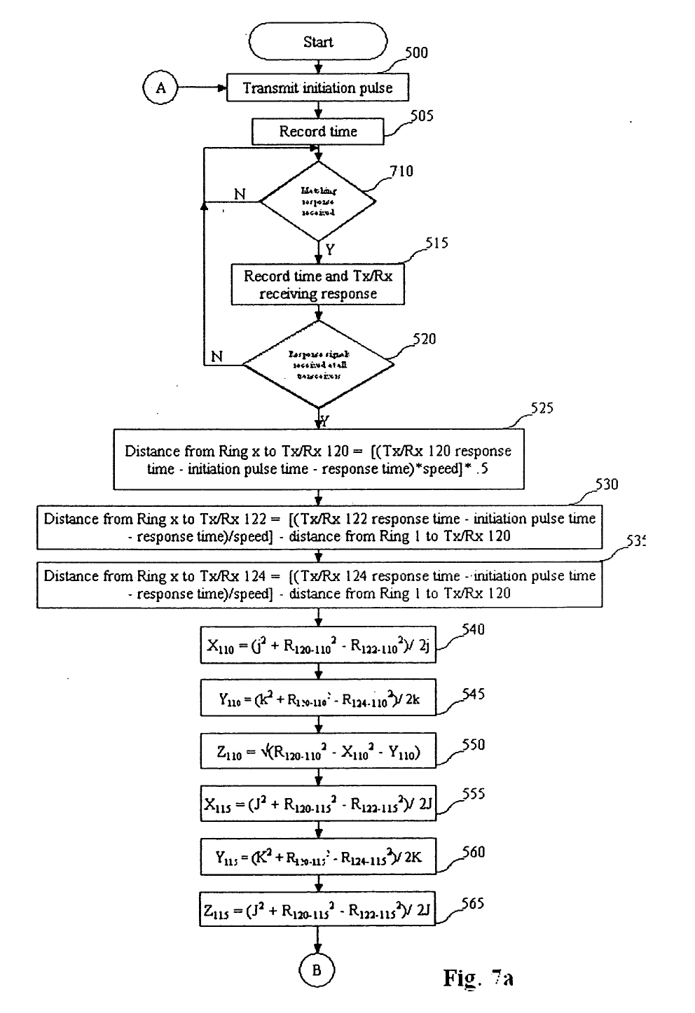

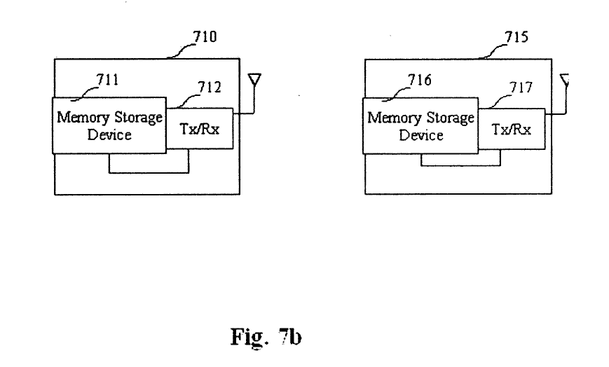

In a fourth embodiment of the present invention, depicted in FIGS. 7, 7a and 7b, mobile transceivers 110 and 115 transmit unique identifiers with each response signal. By including unique identifiers in the response signals, the system can verify that the response signal received is from a specific user's mobile transceivers 110 and 115. As a result, if there are multiple users in front of the device being controlled (for example, computer station 100, laptop 150, PDA 175), microprocessor 200 will only recognize response signals from the active user's mobile transceivers. In addition, microprocessor 200 can restrict access to a device to those with identifiers. Another feature of a fourth embodiment of the present invention is that microprocessor 200 can function when multiple workstations are in close proximity to each other by only generating control signals based on response signals from the active user's mobile transceivers 10 and 115.

FIG. 7 is a flowchart of the initialization procedure of a fourth embodiment of the present invention. In a fourth embodiment of the present invention, the signals transmitted from transceiver 120 to mobile transceivers 110 and 115 (step 500) and the response signals transmitted from mobile transceivers 110 and 115 to transceivers 120, 122 and 124 (step 610) contain unique identifiers. By incorporating a unique identifier into these signals, microprocessor 200 can function when multiple workstations are in close proximity to each other.

FIG. 7 is identical to FIG. 3 except for the addition of step 700. When the system is initialized, the user is prompted to place mobile transceivers 110 and 115 in front of display 130 (as shown in FIG. 1) while no other mobile transceivers are in close proximity and microprocessor 200 records the unique identifiers of mobile transceivers 110 and 115 (step 700).

FIG. 7a is a flowchart of the operation of a fourth embodiment of the present invention. FIG. 7a is identical to FIG. 5 except that step 510 is replaced with step 710. Step 710 checks that a response signal with a matching identifier has been received instead of simply checking that a response signal was received (as in step 510).

FIG. 7b is a block diagram of mobile transceivers 710 and 715. For mobile transceiver 710, transceiver 712 is connected to memory storage device. For mobile transceiver 715, transceiver 717 is connected to memory storage device. When an initiation signal is received by mobile transceiver 710, transceiver 712 transmits the unique identifier stored in memory storage device 711. When an initiation signal is received by mobile transceiver 715, transceiver 717 transmits the unique identifier stored in memory storage device 716.

Another advantage of using unique identifiers in the signals transmitted from transceiver 120 to mobile transceivers 110 and 115 (step 500) and the response signals transmitted from mobile transceivers 110 and 115 to transceivers 120, 122 and 124 (step 610) is that microprocessor 200, if connected to the internet, can download the user's settings from a database connected to the internet when the user first uses a device instead of requiring the user to perform the initialization procedure (as depicted in FIG. 3) on each device. However, this design operates best when each user is the sole user of a given set of mobile transceivers 110 and 115.

In another embodiment of the present invention, each mobile transceiver contains a plurality of transceivers. By including a plurality of transceivers in each mobile transceiver, the vector of the user's hand can be more accurately determined and greater functionality based on the relative position and vector of mobile transceivers 110 and 115 can be achieved.

While the invention has been described with reference to a exemplary embodiments various additions, deletions, substitutions, or other modifications may be made without departing from the spirit or scope of the invention. Accordingly, the invention is not to be considered as limited by the foregoing description, but is only limited by the scope of the appended claims.

I claim:

1. A system for controlling the operation of an electronic device by a user, comprising:
at least two transmitters in communication with said electronic device, wherein said transmitters are adapted to be worn on said user's fingers;
at least one receiver configured to receive signals from said two transmitters; and
a control module in communication with said receiver and configured to send control signals to said electronic device.

2. The system of claim 1, wherein the electronic device comprises a computer system.

3. The system of claim 1, wherein the control signals are cursor control signals.

4. The system of claim 1, wherein the transmitters are configured to generate an identification signal.

5. The system of claim 1, wherein each one of said transmitters is coupled to a ring.

6. The system of claim 1, wherein said receiver is adapted to be in communication with a keyboard.

7. A method of generating control signals for controlling an electronic device comprising:
calculating a three dimensional location of each of at least two transmitters; and
generating a control signal based, at least in part, on changes to the location of at least one of the transmitters.

8. The method of claim 7, wherein the changes to the location of at least one of the transmitters comprise changes in the location of the transmitter relative to at least one receiver.

9. The method of claim 7, wherein the changes to the location of at least one of the transmitters comprise changes in the location of the transmitter relative to at least one other transmitter.

10. The method of claim 7, further comprising:
receiving an identification signal from each of the at least two transmitters wherein the control signal is based, at least in part, on the identification signal.

11. The method of claim 7, wherein the electronic device is a computer and the control signals control the position of a cursor on a computer display.

12. The method of claim 7, the transmitters are adapted to be worn on a user's fingers.

13. The method of claim 7, wherein the electronic device is a personal digital assistant.

14. The method of claim 7, wherein calculating the three dimensional location comprises measuring a transit time of a signal from each of the at least two transmitters to each of at least three receivers.

15. The method of claim 7, wherein generating the control signal is based, at least in part, on comparing the changes in location to a user-defined pattern.

16. A system for controlling an electronic device comprising:
at least two transmitters adapted to be worn on a user's fingers;
at least three receivers configured to receive a signal from the transmitters; and
a controller configured to generate a control signal based, at least in part, on changes to a location of at least one of the transmitters
wherein the controller is configured to calculate the location of each of the transmitters based on a distance of each of the transmitters measured from each of the receivers.

17. The system of claim 16, wherein the electronic device is a computer.

18. The system of claim 16, wherein at least one of the receivers is mounted on said electronic device.

19. A system for controlling an electronic device comprising:
means for calculating a three dimensional location of at least two transmitters; and
means for generating a control signal based, at least in part, on changes in the location of at least one of the transmitters.

20. The system of claim 19, wherein said electronic device is a computer.
